(19) United States
(12) Patent Application Publication
(10) Pub. No.: US 2026/0257164 A1
(43) Pub. Date: Sep. 3, 2026

(54) APPARATUS AND METHOD FOR ADSORBING AND DESORBING CO2 FROM AIR AND A HEAT EXCHANGER

(71) Applicant: FUGU CARBON PTY LTD, Sydney NSW (AU)

(72) Inventor: Luke Alexander Marshall, Glebe NSW (AU)

(73) Assignee: FUGU CARBON PTY LTD, Sydney NSW (AU)

(21) Appl. No.: 19/656,677

(22) Filed: Apr. 23, 2026

Related U.S. Application Data
(63) Continuation of application No. PCT/AU2024/051108, filed on Oct. 22, 2024.

(30) Foreign Application Priority Data
Oct. 25, 2023 (AU) 2023903401
Oct. 25, 2023 (AU) 2023903402

(51) Int. Cl. B01D 53/04

(52) U.S. Cl. CPC B01D 53/0462; B01D 2257/504; B01D 2259/40001

(57) ABSTRACT

An apparatus and a method for adsorbing and desorbing CO₂ from air using a sorbent and temperature-swing adsorption and desorption, and a heat exchanger. The apparatus mainly comprises a control unit, a heat pump, a plurality first and second heat exchanger systems, a plurality of fan systems and a vacuum pump. The apparatus further comprises a plurality of fluid lines that connect the heat pump to the first heat exchanger systems and second heat exchanger systems. The method of adsorbing and desorbing CO₂ from air mainly includes the steps of passing air through the first heat exchanger systems and the second heat exchanger systems, providing a CO₂ sorbent on the second heat exchanger systems, adsorbing of CO₂ molecules via the CO₂ sorbent, desorption of CO₂ molecules via heat transfer from a heat source to the CO₂ sorbent, and evacuating and storing of the CO₂. The heat exchanger includes a plurality of bladders as first fluid lines, with a plurality of second fluid lines external to the bladders, wherein the bladders contract or expand based on the pressure difference of the first and second fluids.

### CROSS-REFERENCE TO RELATED PATENT APPLICATIONS

This Patent Application is a continuation of co-pending PCT Patent Application

No. PCT/AU2024/051108, filed Oct. 22, 2024, which is now pending, the entire teachings and disclosure of which are incorporated herein by reference thereto. This Patent Application claims priority to AU Application No. 2023903401, filed Oct. 25, 2023, and AU Application No. 2023903402, filed Oct. 25, 2023, the entire teachings and disclosure each of which are incorporated herein by reference thereto.

### FIELD OF THE INVENTION

The present invention relates to apparatus and method for adsorbing and desorbing CO₂ from air, and in particular to an energy-efficient apparatus and method for capturing CO₂ using a sorbent and temperature-swing adsorption and desorption. The present invention also relates to a heat exchanger.

The invention has been developed primarily for use in capturing CO₂ and will be described hereinafter with reference to this application. It will, however, be appreciated that the invention is not limited to this particular field of use.

### BACKGROUND OF THE INVENTION

Carbon dioxide (CO₂) is a gas that can be used commercially. CO₂ can be used as a refrigerant, growth accelerant for greenhouse plants, carbonator for drinks, an inflator for life jackets or rafts, and other possible uses. A known way of obtaining CO₂ is through CO₂ capture or adsorption systems.

Prior art CO₂ capture systems commonly feature a mechanism for moving air over a solid sorbent material within a containment vessel. The vessel is subsequently sealed and remaining air is removed by use of a vacuum. The sorbent material is heated by an adjacent or embedded resistive, induction-based or radiative heating system and the sorbent releases CO₂. The CO₂ is subsequently removed by use of the vacuum pump. This process is commonly referred to a Temperature-Swing Adsorption. Some sorbents also require heat in the presence of a rough vacuum, known as Temperature-Vacuum Swing Adsorption.

The high energy consumption of the heating step in this process is one of the key challenges in providing energy efficient capture of CO₂ from gaseous mixtures such as ambient air.

The present invention seeks to provide an apparatus and method for adsorbing and desorbing CO₂ from air, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, an apparatus for adsorbing and desorbing CO₂ from air is provided, the apparatus comprising:
a. a control unit;
b. a heat pump operable by the control unit;
c. a plurality of first heat exchanger systems comprising a plurality of first heat exchangers;
d. a plurality of second heat exchanger systems comprising a plurality of second heat exchangers;
e. a plurality of fan systems operable by the control unit, each fan system comprising a plurality of fans;
f. a vacuum pump operable by the control unit;
g. a plurality of first fluid lines connected to the heat pump and to each first heat exchanger of the plurality of first heat exchangers; the heat pump being adapted to:
   (i) provide a cooled first fluid to each first heat exchanger of the plurality of heat exchangers through the plurality of first fluid lines; and
   (ii) provide a heated second fluid to each first heat exchanger of the plurality of heat exchangers through the plurality of first fluid lines;
h. a plurality of second fluid lines connected to the heat pump and to each second heat exchanger of the plurality of second heat exchangers; the heat pump being adapted to provide a heated second fluid to each second heat exchanger of the plurality of second heat exchangers through the plurality of second fluid lines;
i. a plurality of return first fluid lines connected to the heat pump and to each first heat exchanger of the plurality of first heat exchangers to return the cooled first fluid and the heated second fluid to the heat pump;
j. a plurality of return second fluid lines connected to the heat pump and to each second heat exchanger of the plurality of second heat exchangers to return the heated second fluid to the heat pump;
k. a plurality of first vacuum lines connected to the vacuum pump and to each first heat exchanger of the plurality of first heat exchangers, the vacuum pump being adapted to evacuate air and/or water vapor from the plurality of first heat exchangers;
l. a plurality of second vacuum lines connected to the vacuum pump and to each second heat exchanger of the plurality of second heat exchangers, the vacuum pump being adapted to evacuate air and/or CO2 from the plurality of second heat exchangers;
m. each of the plurality of first heat exchangers comprising:
   a first air filter portion in air connection with at least one fan of the plurality of fans such that operation of the at least one fan will blow air through the first air filter portion;
   a first exchanger fluid line that is in fluid connection with at least one first fluid line of the plurality of first fluid lines and at least one return first fluid line of the plurality of return first fluid lines at another end; and
   a desiccant located within the first air filter portion such that air that passes through the first air filter portion contacts the desiccant;
   wherein the first exchanger fluid line runs through the first air filter portion and is thermally coupled with the desiccant,
   such that during an adsorption phase the desiccant is cooled by the cooled first fluid increasing its adsorption capability and the at least one fan of the plurality of fans is operated by the control unit to blow air through the first air filter portion causing the air to be dehumidified, and during a desorption phase the first air filter portion is heated by the heated second fluid causing vaporization of water accumulated therein and evacuation of the water vapor through at least one vacuum line of the plurality of first vacuum lines;
n. each of the plurality of second heat exchangers comprising:
   a second air filter portion in air connection with the air that exited through a corresponding first heat exchanger of the plurality of first heat exchangers;
   a second exchanger fluid line that is in fluid connection with at least one second fluid line of the plurality of second fluid lines at one end and at least one of the return second fluid lines of the plurality of return second fluid lines at another end; and
   CO₂ sorbent located within the second air filter portion such that air that passes through the second air filter portion contacts the CO2 sorbent;
   wherein the second exchanger fluid line runs through the second air filter portion and is thermally coupled with the CO₂ sorbent;
such that during the adsorption phase the sorbent adsorbs CO₂ molecules from the air that passes through the second heat exchanger and is further cooled by the air which increases its adsorption capability, and during the desorption phase, the CO₂ sorbent is heated by the heated second fluid causing the desorption of CO2 from the CO₂ sorbent and evacuation of the desorbed CO₂ through at least one vacuum line of the plurality of second vacuum lines.

Advantageously, during the adsorption phase, the cooled first fluid that passed through first air filter portion via the first exchanger fluid line is warmed by virtue of heat transfer from the air that is blown by the fan and by the desiccant which adsorbs H₂O in an exothermic reaction. The cooled first fluid that has been warmed is then returned to the heat pump via the return first fluid line. The return of this warm fluid provides another source of heat to the heat pump, which may improve the latter's efficiency in providing heated second fluid during the desorption phase.

In one embodiment, the first air filter portion is coated with the desiccant and the second air filter portion is coated with the sorbent.

In one embodiment, during the adsorption phase the heat pump is adapted to provide the cooled first fluid to the plurality of second heat exchangers through the plurality of second fluid lines such that the CO₂ sorbent is cooled by the cooled first fluid increasing its adsorption capability.

Advantageously, the CO₂ sorbent may be further cooled by the cooled first fluid in addition to cooling by the air that passes through the second exchanger, which makes the CO₂ sorbent more efficient in capturing or adsorbing CO₂ molecules.

In one embodiment, each of the plurality of first heat exchangers comprises a first air-tight enclosure adapted to be controlled by the control unit to selectively enclose the first air filter portion, the first air tight enclosure being in air communication with at least one first vacuum line of the plurality of first vacuum lines.

In one embodiment, the apparatus further comprises a first holding tank and a second holding tank, wherein the evacuated water vapor is stored in the first holding tank and the evacuated CO₂ is stored in the second holding tank.

In one embodiment, the apparatus further comprises a hot fluid tank, wherein the control unit can cause the heat pump to be in fluid communication with a hot fluid tank to store hot fluid.

Advantageously, the hot fluid tank can provide the heated second fluid to the first heat exchanger and second heat exchanger via the heat pump or directly when the heat pump is deactivated.

In one embodiment, the apparatus further comprises a cold fluid tank, wherein the control unit can cause the heat pump to be in fluid communication with a cold fluid tank to store cold fluid.

Advantageously, the cold fluid tank can provide the cooled first fluid to the first heat exchanger or to the second heat exchanger via the heat pump or directly when the heat pump is deactivated.

In one embodiment, the apparatus further comprises a drain line in fluid communication with the first air filter, such that during the adsorption phase when condensate forms, the condensate can drain out of the first air filter through the drain line.

Advantageously, less condensate remains in the first heat exchanger to be vaporized during the desorption phase. This may reduce apparatus energy requirements since less energy is required to be delivered by the heated second fluid.

In one embodiment, the duration of the adsorption phase is between about two and three hours.

In one embodiment, the duration of the desorption phase is between about thirty minutes and one hour.

According to a second aspect of the present invention, a method of adsorbing and desorbing CO₂ from air is provided, the method comprising the steps of:
cooling a first fluid and heating a second fluid;
passing air through a first heat exchanger, the first heat exchanger comprising a first fluid path;
passing the first fluid through the first fluid path such that as the air passes through the first heat exchanger heat is transferred to the first fluid in the first fluid path;
providing a desiccant thermally coupled with the first fluid path such that: (i) the desiccant is cooled, increasing the desiccant's water adsorption capacity and the air in the first heat exchanger is dehumidified via the adsorption of water molecules by the desiccant which, in turn, causes the first fluid to be heated as the desiccant exothermically adsorbs water molecules from the air; (ii) water molecules from the air are condensed to further dehumidify the air;
passing the air that has exited the first heat exchanger through a second heat exchanger, the second heat exchanger comprising a second fluid path; providing a CO₂ sorbent thermally coupled with the second fluid path such that CO₂ is adsorbed from the air as it passes through the second heat exchanger;
removing the H₂O that has been condensed from the air;
evacuating the air from the first heat exchanger and the second heat exchanger;
passing the second fluid through the second fluid path to heat the CO₂ sorbent such that the CO₂ molecules are desorbed from the heated CO₂ sorbent;
evacuating water vapor from the first heat exchanger;
evacuating CO₂ from the second heat exchanger; and
storing the evacuated CO₂;

Advantageously, during the adsorption phase, the cooled first fluid that passes through the first fluid path is warmed by virtue of heat transfer from the air that is blown by the fan and by the desiccant which adsorbs H₂O in an exothermic reaction. The cooled first fluid that has been warmed is then returned to the heat pump via the return first fluid line. The return of this warm fluid provides another source of heat to the heat pump, which may improve the latter's efficiency in providing heated second fluid during the desorption phase.

Advantageously, during the adsorption phase, the cooled first fluid is further heated by the desiccant when the latter exothermically produces heat due to it adsorbing water molecules from the air. This further increases the temperature of the cooled first fluid line when it is returned to the heat pump, acting as an additional source of heat.

In one embodiment, the duration of passing the air through the first heat exchanger is between about two and three hours.

In one embodiment, the duration of removing the water that has been condensed from the air up until the commencement of storing the evacuated CO₂ is between about thirty minutes and one hour.

Advantageously, less condensate remains in the first heat exchanger to be vaporized during the desorption phase. This may reduce apparatus energy requirements since less energy is required to be delivered by the heated second fluid.

In one embodiment, the method further comprises the step of, simultaneous or after the step of passing the first fluid through the first fluid path, passing the first fluid through the second fluid path.

In one embodiment, the method further comprises the step of, simultaneous or after the step of passing the heated second fluid through the second fluid path to heat the CO2 sorbent, passing the heated second fluid through the first fluid path to remove water molecules from the desiccant.

In one embodiment, the method further comprises the step of passing the first fluid that has been heated by the desiccant to a heat pump. According to a third aspect of the present invention, an apparatus is provided for adsorbing and desorbing CO₂ from air, the apparatus comprising:
a. a control unit;
b. a heat pump operable by the control unit;
c. a plurality of fluid pumps operable by the control unit;
d. a cool fluid reservoir
e. a heated fluid reservoir
f. a plurality of first heat exchangers;
g. a plurality of second heat exchangers;
h. a plurality of fans operable by the control unit;
i. a vacuum pump operable by the control unit;
j. the heat pump operable by the control unit to cool the fluid in the cool fluid reservoir such that it can provide a cooled first fluid and to heat the fluid in the heated fluid reservoir such that it can provide a heated second fluid;
k. a first fluid line connected to at least one fluid pump of the plurality of fluid pumps, the cool fluid reservoir, the heated fluid reservoir and to each first heat exchanger of the plurality of first heat exchangers such that the control unit can affect the delivery of:
   i. a cooled first fluid from the cool fluid reservoir via the first fluid line to each first heat exchanger of the plurality of first heat exchangers; and
   ii. a heated second fluid from the heated fluid reservoir via the first fluid line to each first heat exchanger of the plurality of first heat exchangers;
l. a second fluid line connected to at least one fluid pump of the plurality of fluid pumps, the heated fluid reservoir and to each second heat exchanger of the plurality of second heat exchangers such that the control unit can affect the delivery of a heated second fluid from the heated fluid reservoir via the second fluid line to each second heat exchanger of the plurality of first heat exchangers;
m. a return first fluid line connected to each first heat exchanger of the plurality of first heat exchangers and to at least one of: (i) the heated fluid reservoir and (ii) the heat pump.
n. a return second fluid line connected to each second heat exchanger of the plurality of second heat exchangers and to at least one of: (i) the heated fluid reservoir and (ii) the heat pump.
o. a vacuum line connected to the vacuum pump and to each second heat exchanger of the plurality of second heat exchangers, the vacuum pump being adapted to evacuate air and/or CO₂ from the plurality of second heat exchangers;
each of the plurality of first heat exchangers comprising:
   a plurality of spaced first fluid bladders, each of the first fluid bladders comprising an internal volume that is in sealed fluid connection with the first fluid line and the return first fluid line; and
   a volume external to the plurality of spaced first fluid bladders being a first air filter portion, the first air filter portion being in air connection with at least one fan of the plurality of fans such that operation of the at least one fan blows air through the first air filter portion;
   a desiccant located within the first air filter portion such that air that passes through the first air filter portion contacts the desiccant;
   such that during an adsorption phase the at least one fan is operated by the control unit to blow air through the first air filter portion to contact the desiccant to dehumidify the air, and during a desorption phase the first air filter portion is heated by the heated second fluid to cause water to be desorbed from the desiccant for subsequent removal.
each of the plurality of second heat exchangers comprising:
   a plurality of spaced second fluid bladders, each of the second fluid bladders comprising an internal volume that is in sealed fluid connection with the second fluid line and the return second fluid line; and
   a volume external to the plurality of spaced second fluid bladders being a second air filter portion, the second air filter portion being in air connection with the first air filter portion;
   a CO₂ sorbent located within the second air filter portion such that air that passes through the second air filter portion contacts the CO₂ sorbent;
   such that during an adsorption phase the at least one fan is operated by the control unit to blow air through the first air filter portion into the second air filter portion to contact the CO₂ sorbent to adsorb CO₂ from the air, and during a desorption phase the second air filter portion is heated by the heated second fluid causing the desorption of CO₂ from the CO₂ sorbent and the desorbed CO₂ is evacuated through the second vacuum line.

Advantageously, during the adsorption phase, the cooled first fluid that passed through first air filter portion via the first exchanger fluid line is warmed by virtue of heat transfer from the air that is blown by the fan and by the desiccant which adsorbs H₂O in an exothermic reaction. The cooled first fluid that has been warmed is then returned to the heat pump via the return first fluid line. The return of this warm fluid provides another source of heat to the heat pump, which may improve the latter's efficiency in providing heated second fluid during the desorption phase.

Advantageously, the heated fluid reservoir can provide the heated second fluid to the first heat exchanger and second heat exchanger when the heat pump is deactivated.

Advantageously, the cool fluid reservoir can provide the cooled first fluid to the first heat exchanger and second heat exchanger when the heat pump is deactivated.

In one embodiment, the apparatus further comprises a second vacuum line connected to the vacuum pump and to each first heat exchanger of the plurality of first heat exchangers, the vacuum pump being adapted to evacuate air and/or water vapor from the plurality of first heat exchangers through the second vacuum line.

Advantageously, this speeds up the resetting of the first heat exchanger to be used to dehumidify air once again.

In one embodiment, during the adsorption phase the control unit causes the provision of the cooled first fluid to the plurality of second heat exchangers through the second fluid line such that the CO₂ sorbent is cooled by the cooled first fluid increasing its adsorption capability.

Advantageously, the CO₂ sorbent may be further cooled by the cooled first fluid in addition to cooling by the air that passes through the second exchanger, which makes the CO₂ sorbent more efficient in capturing or adsorbing CO₂ molecules.

In one embodiment, each of the plurality of first heat exchangers comprises a first air-tight enclosure adapted to be controlled by the control unit to selectively enclose the plurality of spaced first fluid bladders and the first air filter portion.

In one embodiment, the first air tight enclosure is in air communication with the vacuum line.

In one embodiment, the plurality of second heat exchangers comprises a second air-tight enclosure adapted to be controlled by the control unit to selectively enclose the plurality of spaced second fluid bladders and the second air filter portion, the second air tight enclosure being in fluid communication with the vacuum line.

In one embodiment, the apparatus further comprises a first holding tank and a second holding tank connected to the vacuum line, wherein the control unit is operable to effect water or water vapour that is evacuated via the vacuum line to be stored in the first holding tank and CO₂ that is evacuated via the vacuum line to be stored in the second holding tank.

In one embodiment, the apparatus further comprises a drain line in fluid communication with the first air filter, such that during the adsorption phase when condensate forms, the condensate can drain out of the first air filter through the drain line.

Advantageously, less condensate remains in the first heat exchanger to be vaporized during the desorption phase. This may reduce apparatus energy requirements since less energy is required to be delivered by the heated second fluid.

In one embodiment, the duration of the adsorption phase is between about two and three hours.

In one embodiment, the duration of the desorption phase is between about thirty minutes and one hour.

In one embodiment, the apparatus further comprises a solar fluid subsystem comprising an auxiliary fluid path and a heating region adapted to be exposed to sunlight, the auxiliary fluid path connecting the heated fluid reservoir and the heating region to provide auxiliary heating to the heated fluid in the heated fluid reservoir.

Advantageously, auxiliary heating can be provided to the heated fluid reservoir by sunlight, reducing the energy required to be used by the heat pump to achieve the same temperature.

In one embodiment, the vacuum produced by the vacuum pump is a rough vacuum.

In one embodiment, each of the cool water reservoir and the heated water reservoir are insulated tanks.

In one embodiment, the first cooled fluid in the cool water reservoir and the heated second fluid in the heated fluid reservoir meet threshold temperatures, the control unit is operable to turn off the heat pump.

In one embodiment, the apparatus further comprising a solar energy subsystem adapted to power the heat pump.

In one embodiment, the heat pump is only operated when power is supplied to it from the solar energy subsystem.

In one embodiment, at least a portion of each of the first fluid bladders is flexible such that when the pressure of the first fluid or second fluid in the first fluid bladder is greater than the pressure in the first air filter portion, the first fluid bladder expands into the first air filter portion decreasing the operational volume of the first air filter portion and when the pressure of the first fluid or second fluid is less than the pressure in the first air filter portion, the first fluid bladder contracts, widening increasing the operational volume of the first air filter portion.

Advantageously, increasing the operational volume in the first air filter during the absorption cycle expands the effective cross-sectional area of the first air filter such that air can pass through the first air filter with less drag and therefore more energy efficiently.

Advantageously, reducing the operational volume in the first air filter during the desorption cycle:
1. reduces energy consumption in achieving a vacuum threshold;
2. be used to change the pumping conditions to allow the vacuum pump 1018′ to operate at different operating points, potentially more efficiently,
3. reduces implosion safety risks as there is less vacuum load and therefore less potential energy involved in an implosion; and
4. may cause the at least a portion of each of the first fluid bladder that is flexible to hug against the desiccant thereby increasing surface contact area between the portion and the desiccant achieving higher thermal conduction.

In one embodiment, the entirety of the plurality of first fluid bladders are flexible.

In one embodiment, the at least a portion of each of the first fluid bladders is a wall portion made of a material that is has one or more characteristics from the following group of characteristics.
(a) elasticity
(b) heat conductive; and
(c) thin-walled.

In one embodiment, the material is nylon.

In one embodiment, at least a portion of each of the second fluid bladders is flexible such that when the pressure of the first fluid or second fluid in the second fluid bladder is greater than the pressure in the second air filter portion, the second fluid bladder expands into the second air filter portion decreasing the operational volume of the second air filter portion and when the pressure of the first fluid or second fluid is less than the pressure in the first air filter portion, the first fluid bladder contracts, widening increasing the operational volume of the second air filter portion.

Advantageously, increasing the operational volume in the second air filter during the absorption cycle expands the effective cross-sectional area of the second air filter such that air can pass through the second air filter with less drag and therefore more energy efficiently.

Advantageously, reducing the operational volume in the second air filter during the desorption cycle:
1. reduces energy consumption in achieving a vacuum threshold;
2. be used to change the pumping conditions to allow the vacuum pump 1018′ to operate at different operating points, potentially more efficiently,
3. reduces implosion safety risks as there is less vacuum load and therefore less potential energy involved in an implosion; and
4. may cause the at least a portion of each of the second fluid bladders that is flexible to hug against the CO₂ sorbent thereby increasing surface contact area between the portion and the CO₂ sorbent achieving higher thermal conduction.

In one embodiment, the entirety of the plurality of second fluid bladders are flexible.

In one embodiment, the at least a portion of each of the second fluid bladders is a wall portion made of a material that is has one or more characteristics from the following group of characteristics.
(a) elasticity
(b) heat conductive; and
(c) thin-walled.
   In one embodiment, the material is nylon.

According to a fourth aspect of the present invention, a heat exchanger is provided comprising:
an enclosure having a first fluid inlet, a first fluid outlet, a second fluid inlet and a second fluid outlet;
a plurality of bladders being in sealed fluid communication with the first fluid inlet and the first fluid outlet, each bladder comprising at least a portion comprised of a flexible material;
a plurality of passageways running externally to the plurality of bladders and in sealed fluid communication with the second fluid inlet and the second fluid outlet;
wherein when the pressure of the first fluid is greater than the pressure of the second fluid, the bladders expand into the plurality of passageways and when the pressure of the second fluid is greater than the pressure of the first fluid, the bladders contract, widening the plurality of passageways.

Advantageously, widening the plurality of passageways expands the effective cross-sectional area of the plurality of passageways such that air can pass through the plurality of passageways with less drag and therefore more energy efficiently.

Advantageously, when the bladders expand into the plurality of passageways this:
1. reduces energy consumption in achieving a predetermined vacuum threshold within the plurality of passageways;
2. reduces implosion safety risks as there is less vacuum load, when a vacuum is applied, and therefore less potential energy involved in an implosion; and
3. may cause the at least a portion of each of the bladders that are flexible to hug against a material located inside the plurality of passageways thereby increasing surface contact area between the portions and the material achieving higher thermal conduction.

In one embodiment, each bladder of the plurality of bladders comprises at least one wall, the least one wall being made of a material that is flexible.

In one embodiment, the material is also elastic.

In one embodiment, the material is also heat conductive.

In one embodiment, the material is nylon.

In one embodiment, the material is thin-walled.

This invention may also be said broadly to comprise in the parts, elements, and features referred to or indicated in the specification of the application, individually or collectively, and any or all combinations of any two or more of said parts, elements, or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a schematic diagram of an embodiment of an apparatus for adsorbing and desorbing CO₂ from air;

FIG. 2 shows a front perspective view of an embodiment of the apparatus of FIG. 1;

FIG. 3a shows a front perspective view of an embodiment of an enclosure of a first heat exchanger and a second heat exchanger of the apparatus of FIG. 1;

FIG. 3b shows a front view of the enclosure of FIG. 3a;

FIG. 3c shows a side of the enclosure of FIG. 3a;

FIG. 4a shows a schematic diagram of a first air filter portion and a first exchanger fluid line of the first heat exchanger of the apparatus of FIG. 1;

FIG. 4b shows a schematic diagram of a second air filter portion and a second exchanger fluid line of the second heat exchanger of the apparatus of FIG. 1;

FIG. 5 shows a top view of a filter container of FIG. 2;

FIG. 6 shows a side cross sectional view of the filter container of FIG. 2;

FIG. 7a shows a schematic diagram of an embodiment of a method of adsorbing CO₂ from air;

FIG. 7b shows a schematic diagram of an embodiment of a method of desorbing CO₂ from air;

FIG. 8 shows a schematic diagram of a portion of a heat exchanger in accordance with another embodiment, in an adsorption phase; and

FIG. 9 shows a schematic diagram of the portion of a heat exchanger of FIG. 8 in an desorption phase.

### DESCRIPTION OF EMBODIMENTS

It should be noted in the following description that like or the same reference numerals in different embodiments denote the same or similar features.

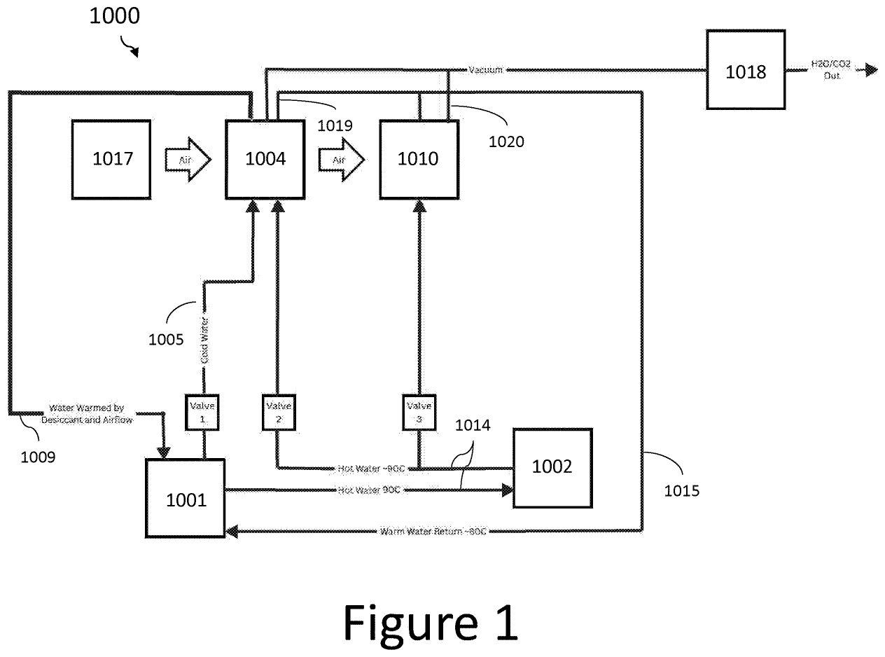

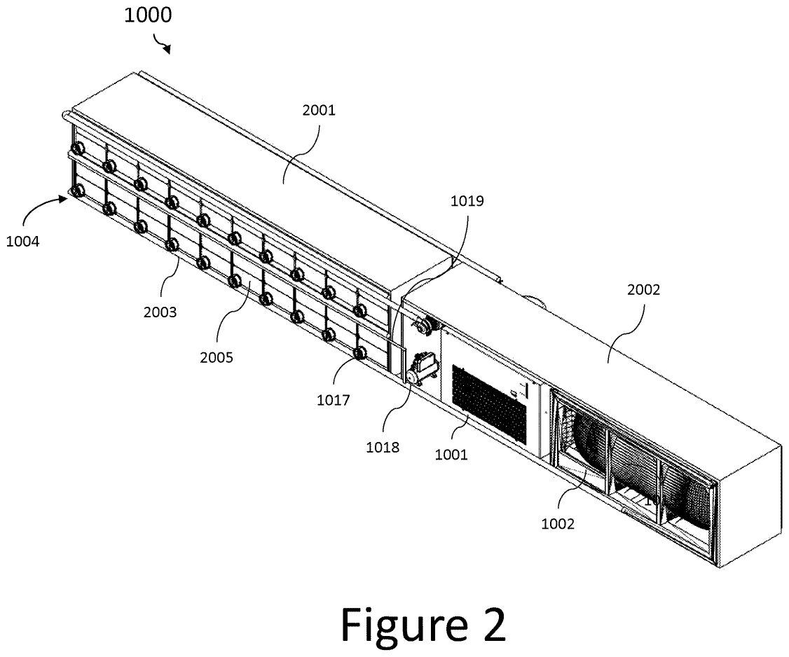

An apparatus 1000 for adsorbing and desorbing CO₂ is shown in FIGS. 1 and 2 and comprises a heat pump 1001, adapted for providing a cooled first fluid and a heated second fluid, a first fluid line 1005, a second fluid line 1014, a return first fluid line 1009 through which the returning cooled first fluid flows and a return second fluid line 1015 through which the returning heated second fluid flows.

The heat pump 1001 may operate in an adsorption phase and a desorption phase. During the adsorption phase, the heat pump is adapted to provide cooled first fluid to the first fluid line 1005. During the desorption phase, the heat pump is adapted provide heated second fluid to the first fluid line 1005 and to the second fluid line 1014. In another embodiment, the heat pump is adapted to provide a cooled first fluid to the second fluid line 1005 during the adsorption phase.

The apparatus 1000 further comprises a control unit (not shown). The control unit is adapted for operating the heat pump 1001 including turning on and off the flow of the cooled first fluid and heat second fluid from the heat pump 1001.

The apparatus 1000 further comprises a first heat exchanger system 1004 and a fan system 1017 coupled to the first heat exchanger system 1004. The first heat exchanger system 1004 includes a plurality of first heat exchangers 2005. Each heat exchanger 2005 comprises a first air filter portion 1006 and a first exchanger fluid line 1007. The first air filter portion 1006 is adapted to allow air blown by the fan system 1017 to pass through.

The first air filter portion 1006 is provided with a desiccant 1008, the desiccant 1008 being adapted to adsorb water molecules from the air passing through the first air filter portion 1006. The desiccant 1008 thermally coupled with the first exchanger fluid line 1005 such that in use, a heat transfer between the desiccant and the fluid flowing through the first exchanger fluid line 1007 occurs.

The first exchanger fluid line 1007 runs through the first air filter portion 1006 and is in fluid connection at one end with a respective first fluid line 1005. In this embodiment the first air filter portion 1007 is coated with the desiccant 1008. In alternative embodiments the desiccant 1008 is indirectly heated by the first fluid line 1005, such as where trays containing desiccant are heated by the first fluid line 1005.

In this embodiment the first fluid line 1005 extends through the first air filter portion 1006 in a serpentine manner to maximise the surface area of the desiccant 1008 exposed to the air as it passes through the first air filter.

When in use during the adsorption phase, the heat pump 1000 is adapted to provide cooled first fluid to the first heat exchanger 1004 through the first fluid line 1005 and the first exchanger fluid line 1006. Consequently, the air blown by the fan system 1017 and passing through the first air filter portion 1006 is cooled by virtue of heat transfer from the air to the cooled first fluid flowing through the first exchanger fluid line 1006. The desiccant 1008 is likewise cooled by virtue of heat transfer from the desiccant to the cooled first fluid flowing through the first exchanger fluid line 1007. When the desiccant is cooled, its capacity for adsorbing water molecules from the air is increased, thereby increasing its effectivity in dehumidifying the air passing through the first air filter portion 1006.

Therefore, there is a dual cooling effect achieved to cool the desiccant. Firstly, there is direct transfer of heat from the desiccant and secondly from air that contacts the desiccant.

The other end of the first exchanger fluid line 1007 is in fluid connection with the return first fluid line 1009 of the heat pump 1000. In use during adsorption phase, the return first fluid line 1009 is adapted to the return the cooled first fluid that passed through the first exchanger fluid line 1007 to the heat pump 1000.

When in use during the desorption phase, the heat pump 1000 is adapted to provide heated first fluid to the first heat exchanger 1004 through the first fluid line 1005 and the first exchanger fluid line 1007. The desiccant 1008 is heated by the heated second fluid flowing through the first heat exchanger fluid line 1007, causing the vaporization of water accumulated within the first air filter portion 1006.

During the desorption phase, the return first fluid line 1009 is adapted to return the heated second fluid that passed through the first exchanger fluid line 1007 to the heat pump 1000.

In other embodiments, the apparatus 1000 may comprise more than one first heat exchanger system 1004 to achieve greater operational capacity.

The apparatus 1000 also comprises a second heat exchanger 1010. The second heat exchanger system 1010 which includes a plurality of second heat exchangers 2006. Each second heat exchanger 2006 comprises a second air filter portion 1011 and a second exchanger fluid line 1012. The second air filter portion 1011 is adapted to receive the air that has passed through the first air filter portion 1004 from the first heat exchanger 1004 and allow it to pass through the second heat exchanger 1010.

The second air filter portion 1011 is provided with a CO₂ sorbent 1013, the CO₂ sorbent 1013 being adapted to adsorb CO₂ molecules from the air passing through the second air filter portion 1011. The second exchanger fluid line 1012 passes through the second air filter portion 1011 and is in fluid connection at one end with the second fluid line 1014. The CO₂ sorbent 1013 is thermally coupled with the second exchanger fluid line 1012 such that in use, a heat transfer between the CO₂ sorbent 1013 and the fluid flowing through the second exchanger fluid line 1012 occurs.

In this embodiment, the second exchanger fluid line 1012 is coated with the CO₂ sorbent 1013 and extends through the second air filter portion 1006 in a serpentine manner to maximise the surface area of the sorbent 1013 exposed to the air as it passes through the second air filter.

When in use during the adsorption phase, the cooled air that exited from the first heat exchanger 1004 enters the second heat exchanger 1010 and passes through the second air filter portion 1011. The CO₂ sorbent 1013 adsorbs CO₂ from the air that passes through the second air filter portion 1011. The CO₂ sorbent 1013 is likewise cooled by virtue of heat transfer from the CO₂ sorbent to the cooled air. When the CO₂ sorbent is cooled, its capacity for adsorbing CO₂ molecules from the air is increased.

In another embodiment during the adsorption phase, the heat pump 1000 is adapted to provide cooled first fluid to the second heat exchanger 1010 through the second fluid line 1014 and the second exchanger fluid line 1012. The CO₂ sorbent 1013 is further cooled by virtue of heat transfer from the CO₂ sorbent to the cooled first fluid flowing through the second exchanger fluid line 1012, which further increases its capacity to adsorb CO₂ molecules from the air.

When in use during the desorption phase, the heat pump 1000 is adapted to provide heated second fluid to the second heat exchanger 1010 through the second fluid line 1014 and the second exchanger fluid line 1012. The CO₂ sorbent 1013 is then heated by virtue of heat transfer from the heated second fluid to the CO₂ sorbent 1013. When the CO₂ sorbent 1013 is heated, the CO₂ molecules from the CO₂ sorbent are desorbed.

The other end of the second exchanger fluid line 1012 is in fluid connection with the return second fluid line 1015 of the heat pump 1000. In use during desorption phase, the return second fluid line 1015 is adapted to return the heated second fluid that went through the second exchanger fluid line 1012 to the heat pump 1000.

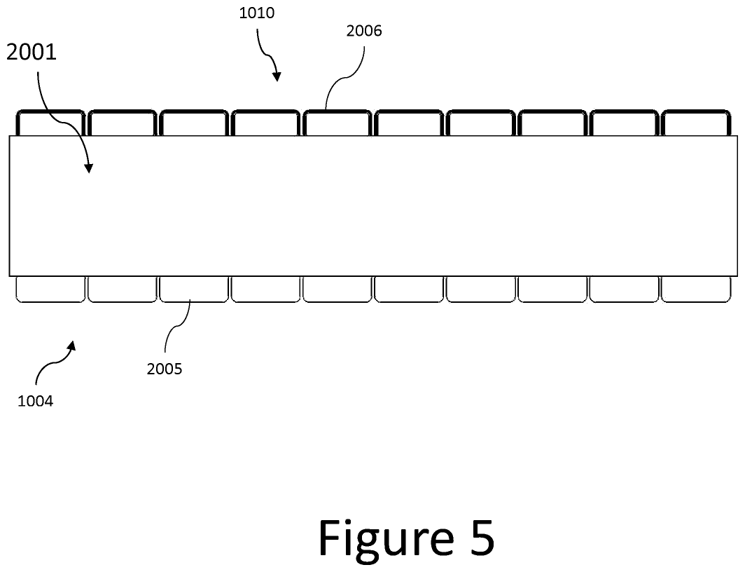

As shown in FIGS. 2, 5 and 6, the first heat exchanger system 1004 and the second heat exchanger system 1010 are arranged in such a way that the first heat exchanger system 1004 is in front of the second heat exchanger system 1010. This means that the first air filter portion 1006 of each of the first heat exchangers 2005 is substantially aligned with the second air filter portion 1007 of a corresponding one of the second heat exchangers 2006 such that air that passes through the first air filter portion 1006 directly into the second air filter portion 1011. This substantial alignment of the first and second air filter 1006, 1007 avoid any unnecessary drag of the airflow which would otherwise be energy inefficient.

As shown in FIG. 2, each fan system 1017 is coupled to the front portion of the corresponding first heat exchanger 2005 such that it is adapted to blow air through the corresponding first air filter portion 1006 in use. The air that is blown by the fan 1017 passes through the first air filter portion 1006, exits therefrom, and subsequently immediately enters the second air filter portion 1010 such that the CO₂ sorbent can adsorb CO₂ molecules from the substantially dehumidified air. Dehumidifying the air prior adsorbing CO₂ increases the efficiency and capacity of the CO₂ sorbent to adsorb CO₂.

In other embodiments, the apparatus 1000 may comprise more than one second heat exchanger system 1010 to achieve greater operational capacity.

The apparatus 1000 further comprises a vacuum pump 1018. The vacuum pump 1018 is connected to the first heat exchanger system 1004 via a first vacuum line 1019 and is connected to the second heat exchanger system 1010 via a second vacuum line 1020. During the desorption phase, the vacuum pump 1018 is adapted to evacuate water vapor and/or air from the first heat exchanger system 1004 and to evacuate CO₂ molecules and/or air from the second heat exchanger system 1010 through the first vacuum line 1019 and second vacuum line 1020, respectively. A valve (not shown) is provided and controlled by the control unit to allow the vacuum pump 1018 to sequentially apply the vacuum to one of the first and second vacuum lines 1019, 1020 then the other.

In an embodiment not shown, the apparatus 1000 further comprises a first holding tank (not shown) and a second holding tank (not shown). The first holding tank is connected to the vacuum pump 1018 and is adapted to store the evacuated water from the first heat exchanger 1004 and the second holding tank is also connected to the vacuum pump 1018 and is adapted to store the CO₂ molecules and/or air from the second heat exchanger 1010.

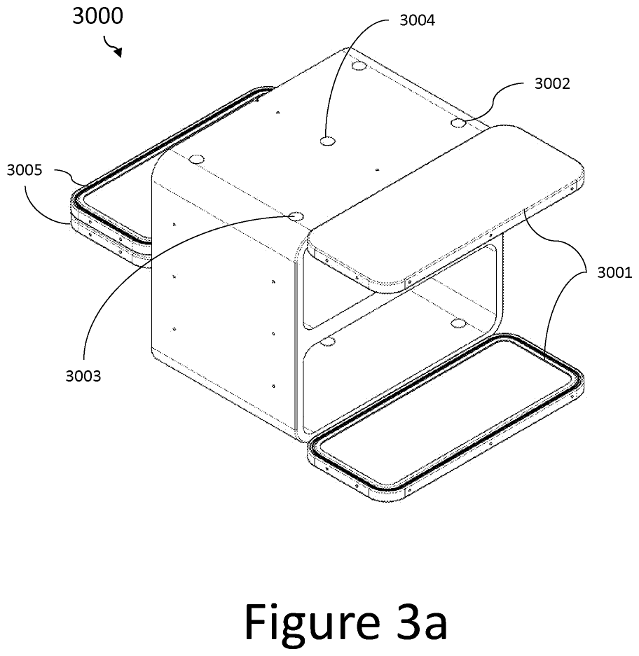

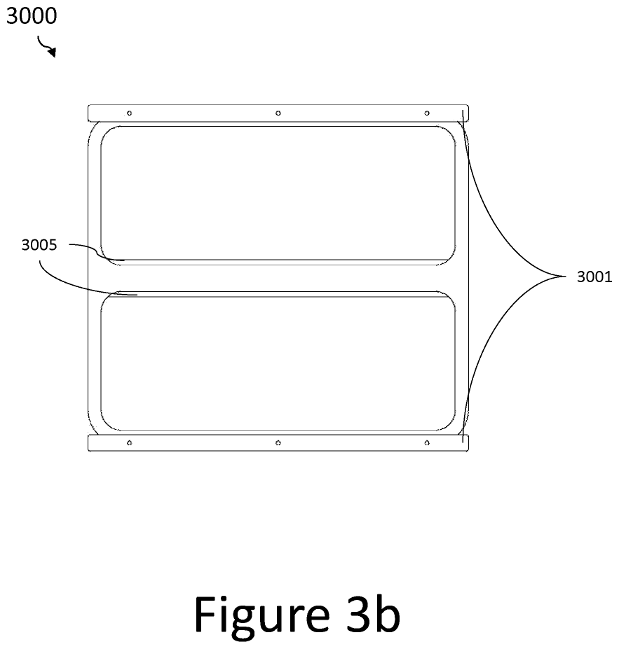

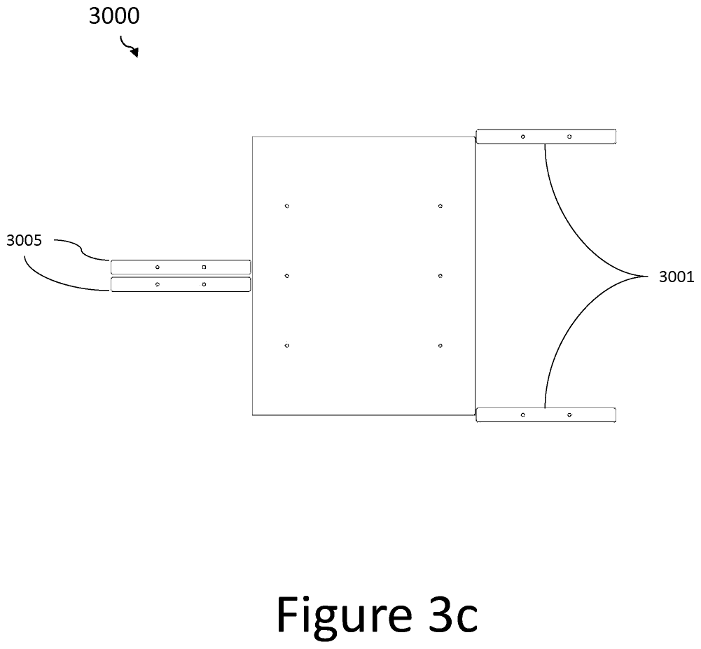

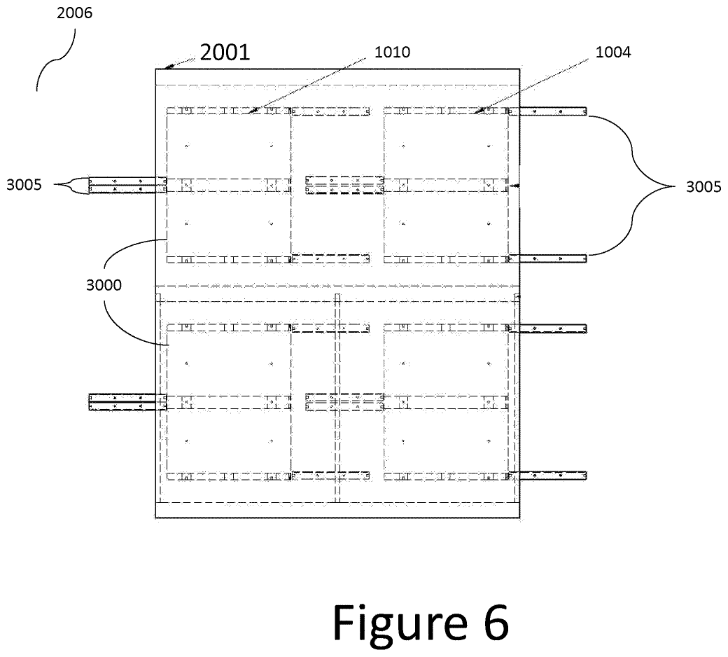

As shown in FIGS. 3a-3c and 6, each of the first heat exchangers 2005 and second heat exchangers 2006 comprises an enclosure 3000 which may be thought of as a containment vessel. The enclosure 3000 comprises a pair of front lids 3001 adapted to cover the front region of the respective first air filter portion 1006 or second air filter portion 1011, a first port 3002 via which the respective one of the first fluid line 1005 or second fluid line 1014 connects to the respective one of the first exchanger fluid line 1007 or second exchanger fluid line 1012 respectively, a second port 3003 at which the respective one of the first exchanger fluid line 1007 or second exchanger fluid line 1012 connects to the respective one of the return first fluid line 1009 or return second fluid line 1015 respectively, a vacuum port 3004 through which the respective one of the first vacuum line 1019 or second vacuum line 1020 is connected, and a pair of rear lids 3005 adapted to cover the end region of the respective one of the first air filter portion 1006 or second air filter portion 1011.

Each enclosure 3000 comprises one or more lid actuation mechanisms coupled to the control until such that the one or more lid actuation mechanisms can open or close the pair of front lids 3001 and the pair of rear lids 3005 responsive to a signal and/or power provided by the control unit.

In a preferred embodiment, the front lids 3001 and rear lids 3005 provide an air-tight seal when closed. During the adsorption phase, the front lids 3001 and rear lids 3005 are opened to allow air blown by the fans 1017 to pass through the first air filter portion 1004 and second air filter portion 1010. During the desorption phase, the front lids 3001 and rear lids 3005 are closed such that the first air filter potion 1004 and second air filter portion 1010 are isolated from outside air and such that their contents may be evacuated by the vacuum pump 1018 via the first and second vacuum lines 1019, 1020 respectively.

Alternative enclosures for each of the first heat exchangers 2005 and second heat exchangers 2006 are envisaged. Such enclosures may not require closures in the form of lids and other closures are envisaged such as pop and screw type fittings.

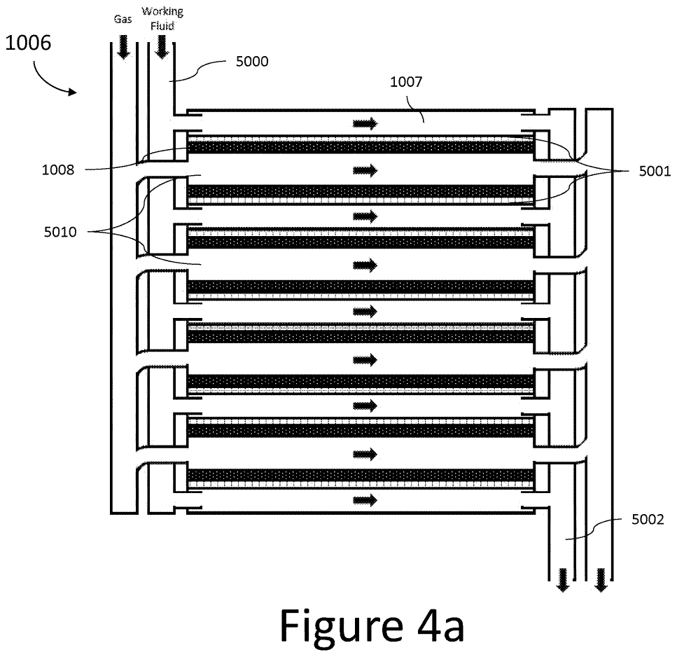

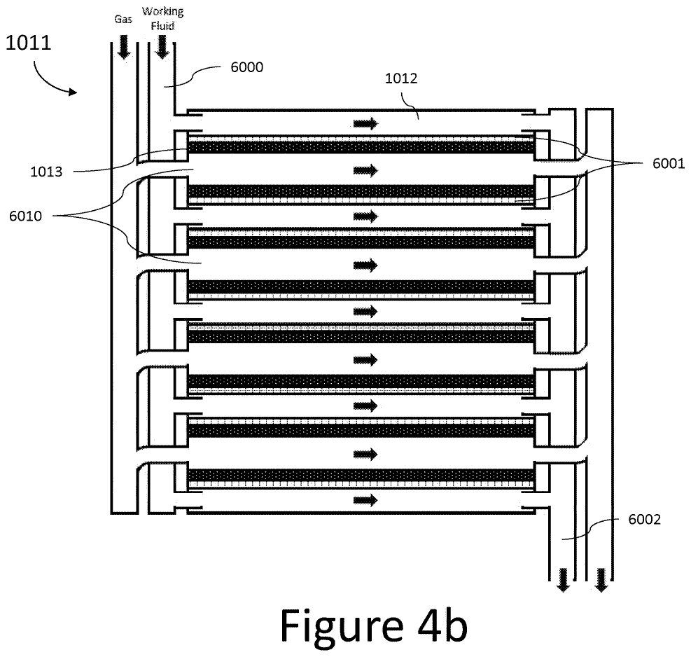

Referring to FIG. 4a, the first exchange fluid line 1007 comprises an inlet region 5000, a plurality of branched, wide heat exchange portions 5001 and an outlet region 5002. The plurality of branched heat exchange portions 5001 branch out after the inlet region 5000 and reconnect before the outlet region 5002. The heat exchange portions 5001 are spaced from each other to define the first air filter portion 1006 which comprises a corresponding plurality of first air passages 5010 defined between the heat exchange portions 5001. The heat exchange portions are thin, heat-conductive and have a high tensile strength to withstand the pressure differential during the desorption phase when a vacuum is applied to the first air filter portion 1006. The heat exchange portions 5001 may be made from nylon or any other suitable material.

The wide heat exchange portions 5001 offer the advantage of higher contact surface area for the air with the desiccant while allowing a vacuum to be applied to the desiccant.

In some embodiments, the wide heat exchange portions 5001 may deformably stretch or otherwise flex.

In some embodiments, the desiccant may traverse each of the plurality of first air passages 5010 but comprise gaps or pathways for the air to pass through. Advantageously, in this case, during desorption, a vacuum is pulled with minimal free space thereby reducing energy wasted on evacuating large volumes unnecessarily.

Referring to FIG. 4b, the second exchange fluid line 1012 comprises an inlet region 6000, a plurality of branched, wide heat exchange portions 6001 and an outlet region 6002. The plurality of branched heat exchange portions 6001 branch out after the inlet region 6000 and reconnect before the outlet region 6002. The heat exchange portions 6001 are spaced from each other to define the second air filter portion 1011 which comprises a corresponding plurality of first air passages 6010 defined between the heat exchange portions 6001. The heat exchange portions are thin, heat-conductive and have a high tensile strength to withstand the pressure differential during the desorption phase when a vacuum is applied to the second air filter portion 1011. The heat exchange portions 6001 may be made from nylon or any other suitable material.

The wide heat exchange portions 6001 offer the advantage of higher contact surface area for the air with the CO² Sorbent while allowing a vacuum to be applied to the CO² Sorbent.

In some embodiments, the wide heat exchange portions 6001 may deformably stretch or otherwise flex.

In some embodiments, the CO² sorbent may traverse each of the plurality of second air passages 6010 but comprise gaps or pathways for the air to pass through. Advantageously, in this case, during desorption, a vacuum is pulled with minimal free space thereby reducing energy wasted on evacuating large volumes unnecessarily.

In alternative embodiments, additional structural layers may be added to the first and second exchange fluid lines 1007, 1012 or to the first and second air filter portions 1006,1011 to provide greater rigidity under vacuum or high working fluid pressures.

The apparatus 1000 may further comprise a drain line 2003 as shown in FIG. 2. The drain line 2003 is in fluid communication with first air filter portion 1006, such that during the adsorption phase when condensate forms, the condensate can drain out of the first air filter portion through the drain line. Advantageously, less condensate remains in the first heat exchangers 2005 to be vaporized during the desorption phase. This may reduce apparatus 1000 energy requirements since less energy is required to be delivered by the heated second fluid.

As shown in FIGS. 1-2, the apparatus comprises a hot fluid tank 1002. The heat pump 1001 is in fluid connection with a hot fluid tank 1002 via a first tank fluid line 1021. During use, the heat pump may be operated to provide heated second fluid to the first fluid line 1005 and second fluid line 1011, or it may be operated to provided heated second fluid to the first tank fluid line 1021 for storage. The stored heated second fluid can readily be provided by the hot fluid tank 1002 if needed even if the heat pump 1001 is deactivated. The stored heated second fluid can be provided to the first fluid line 1005 and/or the second fluid line 1014 via the heat pump 1001 or via a direct connection (not shown). If the stored heated second fluid is provided by direct connection a further pumping device may be required to pump the fluid out of the tank into the first fluid line 1005 and/or second fluid line 1014.

In an embodiment not shown, the apparatus 1000 further comprises a cold fluid tank (not shown) that is in fluid connection with the heat pump 1001. The heat pump 1001 is in fluid connection with the cold fluid tank via a second tank fluid line (not shown). During use, the heat pump may be operated to provide cooled first fluid to the first fluid line and second fluid line 1011, or it may be operated to provided cooled second fluid to the first tank fluid line for storage. The stored cooled first fluid can readily be provided by the cold fluid tank if needed even if the heat pump 1001 is deactivated. The stored cooled first fluid can be provided to the first fluid line 1005 and/or the second fluid line 1014 via the heat pump 1001 or via a direct connection (not shown). If the stored cooled first fluid is provided by direct connection a further pumping device may be required to pump the fluid out of the tank into the first fluid line 1005 and/or second fluid line 1014.

Moreover, each of the plurality of first heat exchangers 1004 is connected to the first vacuum line 1019 and each of the plurality of second heat exchangers 1010 is connected to the second vacuum line 1020. The plurality of first heat exchangers 1004 and the plurality of second heat exchangers 1010 are located in a filter container 2001. The heat pump 1001, vacuum pump 1018 and hot fluid tank 1002 are located in a services container 2002. In the services container 2002, the heat pump 1001 is in between the vacuum pump 1018 and hot fluid tank 1002. The filter container 2001 is arranged adjacent to the services container 2002 in use such that the vacuum pump 1018 is the most proximate to the filter container 2001 and the hot fluid tank 1002 is the most distant to the filter container 2001.

Each of the filter container 2001 and the services container 2002 may be a shipping container.

The location of various components in one or more apparatus enclosures or housings, such as containers, and the placement of parts or components relative to each other may be determined based on application-specific and operational requirements.

In this embodiment, the thermal coupling between the desiccant and the first exchanger fluid line 1007 is one of conduction and the thermal coupling between the CO₂ sorbent and the second exchanger fluid line 1012 is one of conduction. In other embodiments, other modes of thermal coupling are envisaged such as convection.

The following description describes an alternative embodiment not shown in FIG. 1. Some of the features are the same or similar to those shown in FIGS. 2 to 6 and accordingly, the same reference numerals will be used for such features, albeit with the addition of a prime.

An apparatus 1000′ for adsorbing and desorbing CO₂ is provided and comprises a control unit, a heat pump 1001 operable by the control unit, a plurality of fluid pumps operable by the control unit, a cool fluid reservoir, a heated fluid reservoir, a plurality of first heat exchangers 2005′, a plurality of second heat exchangers 1010′; a plurality of fans 1017′ operable by the control unit and a vacuum pump 1018′ operable by the control unit.

The heat pump 1001′ is operable by the control unit to:
o. cool the fluid in the cool fluid reservoir such that it can provide a cooled first fluid, and
p. heat the fluid in the hot fluid reservoir such that it can provide a heated second fluid;

The apparatus 1000′ further has a first fluid line 1005′ connected to at least one fluid pump of the plurality of fluid pumps, the cool fluid reservoir, the heated fluid reservoir and to each first heat exchanger of the plurality of first heat exchangers such that the control unit can affect the delivery of:
q. a cooled first fluid from the cool fluid reservoir via the first fluid line to each first heat exchanger of the plurality of first heat exchangers; and
r. a heated second fluid from the heated fluid reservoir via the first fluid line to each first heat exchanger of the plurality of first heat exchangers;

In this embodiment, the control unit affects this by actuating the relevant fluid pump and controlling relevant valves in the first fluid line 1005′ to ensure the cooled first fluid and heated second fluid are pumped along the appropriate pathways.

The apparatus 1000′ further has a second fluid line 1014′ connected to at least one fluid pump of the plurality of fluid pumps, the heated fluid reservoir and to each second heat exchanger 1010′ of the plurality of second heat exchangers such that the control unit can affect the delivery of a heated second fluid from the heated fluid reservoir via the second fluid line 1014′ to each second heat exchanger 1010′ of the plurality of second heat exchangers.

The apparatus 1000′ further has:
s. a return first fluid line 1009′ connected to each first heat exchanger 1004′ of the plurality of first heat exchangers and to the heated fluid reservoir; and
t. a return second fluid line connected to each second heat exchanger 1010′ of the plurality of second heat exchangers and to the hot fluid reservoir.

The apparatus 1000′ further has a vacuum line connected to the vacuum pump 1018′ and to each second heat exchanger 1010′ of the plurality of second heat exchangers, the vacuum pump 1018′ being adapted to evacuate air and/or CO₂ from the plurality of second heat exchangers.

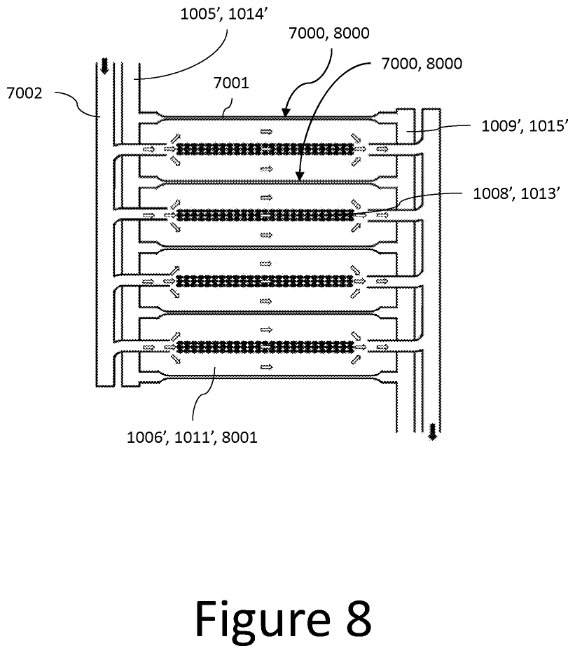

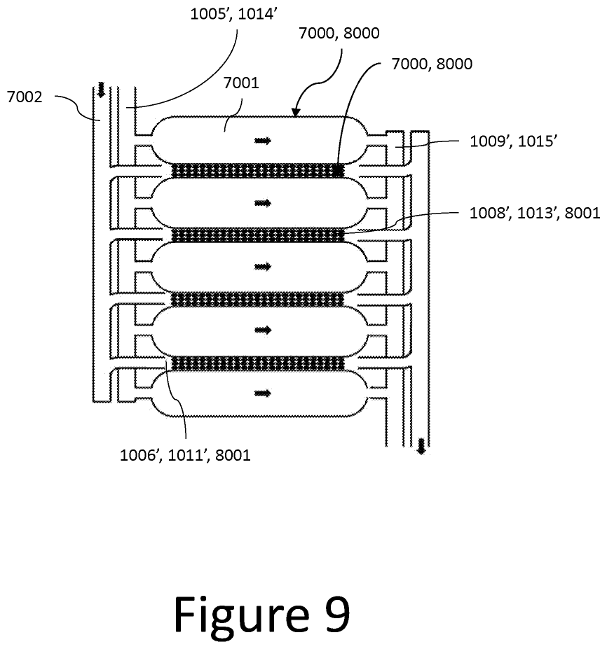

FIGS. 8 and 9 show, schematically, the structure and function of parts of the first heat exchanger 2005′ and second heat exchanger 1010′, in an adsorption and desorption phase, respectively. Specifically, what is shown is a plurality of spaced fluid bladders 7000. The spaced fluid bladders 7000 of the first heat exchanger 1004′ we will call first spaced fluid bladders and in the same manner second spaced fluid bladders are provided by the second heat exchanger 1010′. The bladders 7000 are flexible, heat conductive and thin-walled. In other embodiments, only a portion of the bladders 7000 may be flexible. In yet another alternative, the bladders may be elastic.

Each of the fluid bladders 7000 comprises an internal volume 7001 that is in sealed fluid connection with the first fluid line 1005′ and the return first fluid line 1009′ in the first heat exchanger 1004′ and is in sealed fluid connection with the second fluid line 1014′ and the return second fluid line 1015′ in the second heat exchanger 1010′. A volume external to the plurality of spaced first fluid bladders is a first air filter portion 1006′ in respect of the first heat exchanger 2005′ and is a second air filter portion 1011′ in respect of the second heat exchanger 1010′.

The first air filter portion 1006′ is in air connection with at least one fan system 1017′ which blows an air current through the air pipe 7002. In one embodiment the air pipe 7002 may simply pipe in ambient air from the region surrounding the apparatus 1000′ The second air filter portion 1011′ receives air that has already passed through the first air filter 1006′. Preferably, the air filters are aligned for aerodynamic efficiency but this is not shown in FIGS. 8 and 9.

Desiccant 1008′ and CO₂ sorbent 1013′ are located within the first air filter portion 1006′ and the second air filter portion 1011', respectively, such that the respective air flow contacts the desiccant 1008′ and CO₂ sorbent 1013′ respectively.

In the first heat exchanger 1004′, during the adsorption phase shown in FIG. 8, the control unit operates the fan to cause a pressure to be exerted on the fluid bladders 7000. This is because the pressure of the air being fanned down the pipe 7002, is greater than the internal pressure within the fluid bladders 7000, causing the bladders 7000 to contract. The bladders 7000 may also be empty or partially empty. Accordingly, during the adsorption phase the first air filter portion 1006′ has a greater cross-sectional area allowing the air to flow through and around the desiccant 1008′ with less resistance. This reduces energy requirements on the fan system 1017′. Adjustment of the internal pressure of the fluid bladders 7000, enables careful tuning of the airflow and airspeed across the desiccant, which impacts desiccation properties. The air contacts the desiccant 1008′ to dehumidify the air.

In the second heat exchanger 1010′, during the adsorption phase shown in FIG. 8, the control unit operates the fan to blow air through the first air filter portion 1006′ into the second air filter portion 1011′ to cause a pressure to be exerted on the fluid bladders 7000. This is because the pressure of the air entering from the first filter portion is greater than the internal pressure within the fluid bladders 7000, causing the bladders 7000 to contract. The bladders 7000 may also be empty or partially empty. Accordingly, during the adsorption phase the second air filter portion 1011′ has a greater cross-sectional area allowing the air to flow through and around the CO₂ sorbent with less resistance. This reduces energy requirements on the fan system 1017′. Adjustment of the internal pressure of the fluid bladders 7000, enables careful tuning of the airflow and airspeed across the CO₂ sorbent, which impacts adsorption properties. The air contacts the CO₂ sorbent to which adsorbs CO₂ from the air.

In the first heat exchanger 1004′, during the desorption phase shown in FIG. 9, the heated second fluid passes through the first fluid line 1005′, into the bladder 7000 and out the second fluid line 1014′. Because the pressure exerted by the heated second fluid is greater than the pressure in the first air filter portion 1006′ the bladders ballon outwardly and, in this embodiment, make contact with the desiccant 1008′ in the first air filter portion 1006′. Heat is conducted from the heated second fluid through the wall of the bladder 7000 into the desiccant 1008′, heating the desiccant 1008′. This causes the desiccant to desorb H₂O which is then drained out a drain line 2003′ (not shown in FIG. 9). In a rough vacuum can also be applied to the first air filter portion 1006′ to aid in this process. The drain line can also drain any condensate.

In the second heat exchanger 1011', during the desorption phase shown in FIG. 9, the heated second fluid passes through the second fluid line 1014′, into the second bladders 7000 and out the return second fluid line 1015′. Because the pressure exerted by the heated second fluid is greater than the pressure in the air filter portion 1011′ the bladders ballon outwardly and, in this embodiment, make contact with the CO₂ sorbent in the first air filter portion 1011′. Heat is conducted from the heated second fluid through the wall of the bladder 7000 into the CO₂ sorbent, heating the CO₂ sorbent. This causes the CO₂ sorbent to desorb CO₂ which is then removed from the second air filter 1011′ when the control unit operates the vacuum pump 1018′ and relevant valve to apply a vacuum to the second air filter 1011′ to evacuated the CO₂ through the second vacuum line 1020′ into a CO₂ storage tank.

Advantageously, reducing the operational volume in the first and second air filters 1006′, 1011′ during the desorption cycle may further:
1. reduces energy consumption in achieving a vacuum threshold;
2. be used to change the pumping conditions to allow the vacuum pump 1018′ to operate at different operating points, potentially more efficiently,
3. reduces implosion safety risks as there is less vacuum load and therefore less potential energy involved in an implosion; and

During the adsorption phase, a cooled first fluid may be passed through the plurality of first bladders 70000 portion and be warmed by virtue of heat transfer through the bladder walls by the air that is blown by the fan and by the desiccant which adsorbs H₂O in an exothermic reaction. The cooled first fluid that has been warmed may then be returned to the heat pump 1001′ or to the heated fluid reservoir via the return first fluid line 1009′. The return of this warm fluid provides another source of heat to the heat pump or heated fluid reservoir, which may improve the latter's efficiency in providing heated second fluid during the desorption phase.

Advantageously, the heated fluid reservoir can provide the heated second fluid to the first heat exchanger and second heat exchanger when the heat pump is deactivated.

Advantageously, the cool fluid reservoir can provide the cooled first fluid to the first heat exchanger and second heat exchanger when the heat pump is deactivated.

In one embodiment, the apparatus further comprises a second vacuum line 1020′ connected to the vacuum pump 1018′ and to each first heat exchanger 1004′ of the plurality of first heat exchangers, the vacuum pump 1018′ being adapted to evacuate air and/or water vapor from the plurality of first heat exchangers (specifically, from the first air filter portions 1006′) through the second vacuum line 1020′. Advantageously, this speeds up the resetting of the first heat exchanger 1004′ to be used to dehumidify air once again.

In one embodiment, during the adsorption phase the control unit causes the provision of the cooled first fluid to the plurality of second heat exchangers 1010′ through the second fluid line 1014′ such that the CO₂ sorbent is cooled by the cooled first fluid increasing its adsorption capability.

Advantageously, the CO₂ sorbent may be further cooled by the cooled first fluid in addition to cooling by the air that passes through the second exchanger, which makes the CO₂ sorbent more efficient in capturing or adsorbing CO₂ molecules.

In one embodiment, each of the plurality of first heat exchangers 1004′ comprises a first air-tight enclosure adapted to be controlled by the control unit to selectively enclose the plurality of spaced first fluid bladders 7000 and the first air filter portion 1006′. In one embodiment, the first air tight enclosure is in air communication with the first vacuum line 1019′.

In one embodiment, the plurality of second heat exchangers 1011′ comprises a second air-tight enclosure adapted to be controlled by the control unit to selectively enclose the plurality of spaced second fluid bladders 7000 and the second air filter portion 1011′, the second air tight enclosure being in fluid communication with the vacuum line 1020′.

In one embodiment, the apparatus 1000′ further comprises a first holding tank and a second holding tank connected to the first and second vacuum lines 1019′, 1020′, wherein the control unit is operable to effect water or water vapour that is evacuated via the respective vacuum line to be stored in the first holding tank and CO₂ that is evacuated via the second vacuum line 1020′ to be stored in the second holding tank.

In one embodiment, the duration of the adsorption phase is between about two and three hours.

In one embodiment, the duration of the desorption phase is between about thirty minutes and one hour.

In one embodiment, the apparatus 1000′ incorporates a solar fluid subsystem comprising an auxiliary fluid path and a heating region adapted to be exposed to sunlight, the auxiliary fluid path connects the heated fluid reservoir and the heating region to provide auxiliary heating to the heated fluid in the heated fluid reservoir. Advantageously, auxiliary heating can be provided to the heated fluid reservoir by sunlight, reducing the energy required to be used by the heat pump to achieve the same temperature.

Any of the tanks or reservoirs mentioned may be suitably insulated.

In one embodiment, the first cooled fluid in the cool water reservoir and the heated second fluid in the hot water reservoir meet threshold temperatures, the control unit is operable to turn off the heat pump.

In one embodiment, the apparatus 1000′ further comprises a solar energy subsystem adapted to power the heat pump 1001′. The heat pump 1001′ may only be operated when power is supplied to it from the solar energy subsystem.

The CO₂ sorbent may take the form of an integrated, porous mass in-between adjacent bladders 7000, a series of balls or beads collected together in porous bags or another form.

FIGS. 8 and 9 further illustrate portions of a novel heat exchanger that may be operated as part of systems unrelated to the applications in H₂O or CO₂ adsorption described above.

The novel heat exchanger has an enclosure having a first fluid inlet, a first fluid outlet, a second fluid inlet and a second fluid outlet. The heat exchanger 8000 also has a plurality of bladders 8001 being in sealed fluid communication with the first fluid inlet and the first fluid outlet, each bladder comprising at least a portion comprised of a flexible material. The heat exchanger 8000 has a plurality of passageways 8001 running externally to the plurality of bladders and in sealed fluid communication with the second fluid inlet and the second fluid outlet. The heat exchanger 8000 is such that when the pressure of the first fluid is greater than the pressure of the second fluid, the bladders expand into the plurality of passageways 8001 and when the pressure of the second fluid is greater than the pressure of the first fluid, the bladders 8000 contract, widening the plurality of passageways 8001.

Advantageously, widening the plurality of passageways 8001 expands the effective cross-sectional area of the plurality of passageways 8001 such that air can pass through the plurality of passageways 8001 with less drag and therefore more energy efficiently.

Advantageously, when the bladders 8000 expand into the plurality of passageways 8001 this:
u. reduces energy consumption in achieving a predetermined vacuum threshold within the plurality of passageways;
v. reduces implosion safety risks as there is less vacuum load, when a vacuum is applied, and therefore less potential energy involved in an implosion; and
w. may cause the at least a portion of each of the bladders that are flexible to hug against a material located inside the plurality of passageways thereby increasing surface contact area between the portions and the material achieving higher thermal conduction.

In various embodiments the bladders 8000 of the plurality of bladders comprises at least one wall, the least one wall being made of a material that is flexible. The material may also be elastic, heat conductive and or thin-walled. Any suitable material may be used for the bladders 8000 for example various polymers or nylon.

Advantageously, where a sorbent material is embedded within the plurality of passageways 8001 the expansion of the bladders 8001 may bring the bladders 8001 into contact with the embedded sorbent enabling greater heat transfer. Effectively, therefore heat can be exchanged between a fluid within the bladders 8000 and the sorbent material in this case.

In embodiments, the adsorption phase is between about two and three hours and the desorption phase is between about thirty minutes and one hour. In other embodiments, the duration of the adsorption and desorption phases may vary depending on a range of factors including but not limited to:
(a) the volume, mass, form or types of sorbent or desiccant employed
(b) PPM Co2 levels, temperature, humidity and pressure of the ambient air, and consequently the amount of water (that needs to be removed from the desiccant first) or condensate that needs to be drained.
(c) the power rating of the heat pump
(d) the size, mass and insulative properties of the apparatus, or
(e) operational requirements

In this embodiment the first and second fluids are water, however any other suitable fluid may be used.

Any of the fluids described in this specification may take the form of a gas or a liquid.

Sensors made be added to the first heat exchanger system 1004, 1004′ the second heat exchanger system 1010, 1010′, the heat pump, the hot fluid tank 1002 the cold fluid tank, to any of the lines, bladders or regions or any other part of the apparatus to measure and monitor parameters such as air or other fluid flow rate, temperature or pressure as required.

In a further embodiment, aspects or parts of one embodiment may be co-joined with aspects or parts of another embodiment.

It should also be appreciated that the apparatus 1000, 1000′ may include one-way, fluid re-direction or other valves not specifically mentioned that are controlled by the control unit to effect the fluid flows described in this specification.

The hardware of the control unit may any suitable such unit known in the art, for example including a micro-processor adapted to execute instructions stored in memory to which the micro-processor is operatively connected. All parts of the apparatus 1000, 1000′ that require power to operate may be connected to a suitable power source such as mains power or a battery.

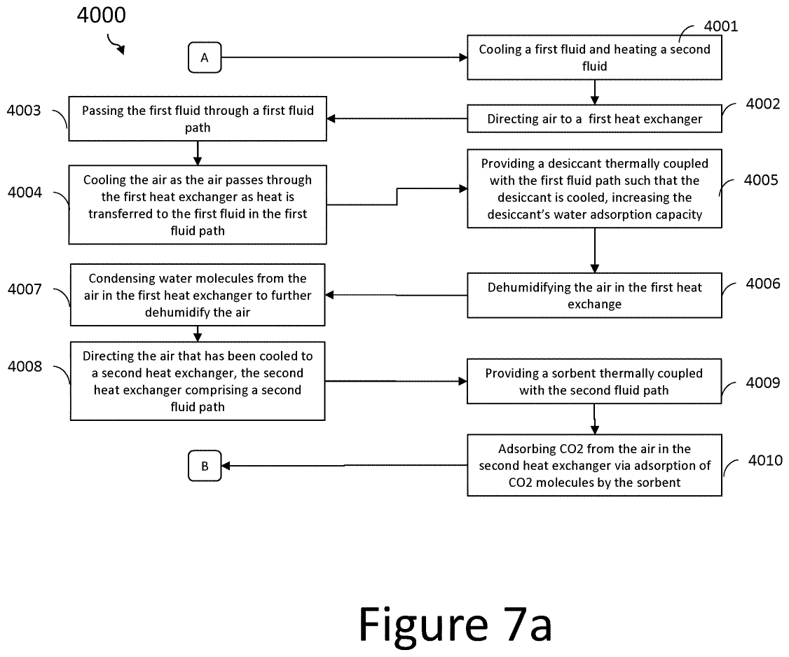

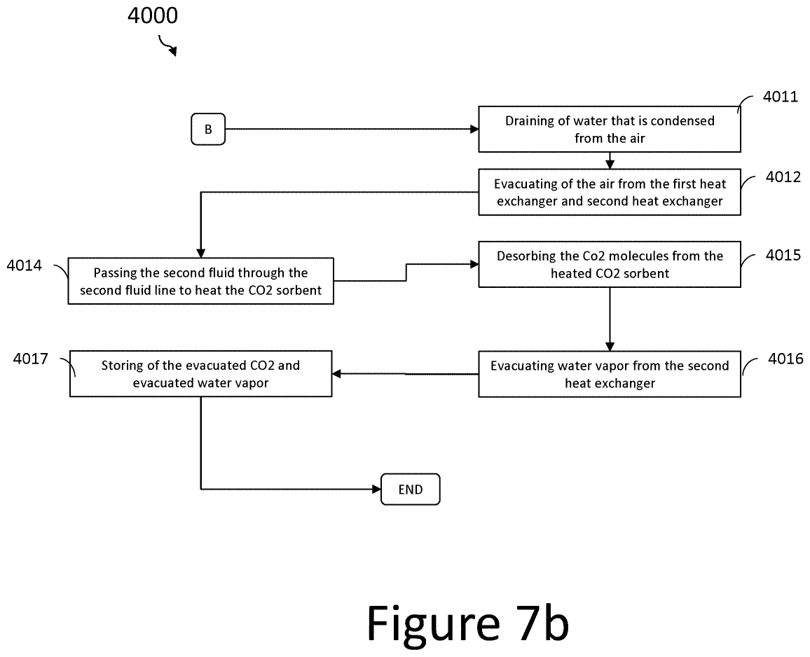

FIGS. 7a and 7b shows a method 4000 of adsorbing and desorbing CO₂ from air. Specifically, FIG. 7a shows the adsorption phase of the method and FIG. 7b shows the desorption phase of the method. The method comprises a first step 4001 of cooling a first fluid and heating a second fluid. The air is then directed 4002 to a first heat exchanger 2005. The first fluid is then passed through 4003 the first fluid line 1005 of the first heat exchanger 2005. The fourth step 4004 is cooling the air as the air passes through the first heat exchanger 2005 as heat is transferred to the first fluid in the first fluid line 1005. A desiccant 1008 is provided 4005, the desiccant being thermally coupled with the first fluid line 1005 such that the desiccant 1008 is cooled, increasing the desiccant's water adsorption capacity.

The air is dehumidified 4006 in the first heat exchanger 1004 via the adsorption of water molecules by the desiccant 1008 causing the first fluid to be heated as the desiccant exothermically adsorbs water molecules from the air. The water molecules from the air in the first heat exchanger are then condensed 4007 to further dehumidify the air. The air that has been cooled is directed 4008 to a second heat exchanger 2006. A CO₂ sorbent 1013 is provided 4009 which is thermally coupled with the second fluid line 1014. The CO₂ from the air in the second heat exchanger 2006 is adsorbed 4010 via adsorption of CO₂ molecules by the CO₂ sorbent.

The water that has been condensed 4011 from the air is drained and the air from the first heat exchanger 2005 and the second heat exchanger 1010 is evacuated 4012. The next step is passing 4014 the second fluid through the second fluid line 1014 to heat the CO2 sorbent 1013. The CO₂ molecules are then desorbed 4015 from the heated CO2 sorbent 1013. The water vapor from the first heat exchanger 2005 is evacuated 4016 and the CO₂ from the second heat exchanger 2006 is likewise evacuated 2017. Finally, the CO₂ that has been evacuated is stored 4017.

In another embodiment, the method 4000 comprises a step of passing the cool first fluid through the second fluid line 1014 simultaneous or after the step of passing 4003 the first fluid through the first fluid line 1005. In another embodiment, the method 4000 comprises a step of passing the second fluid through the first fluid line 4005 to vaporize water molecules or condensate accumulated in the first heat exchanger 2005 simultaneously or after the step of passing the second fluid through the second fluid line 1014 to heat the CO2 sorbent. The water molecules or condensate that is vaporizes may be present in the open volume of the first heat exchanger or have been adsorbed by the desiccant.

Furthermore, the method comprises a heat recovery portion, wherein during the adsorption phase, the cooled first fluid that passed through the first heat exchanger 2005 and is consequently heated by the desiccant 1008 and by the incoming air is returned to the heat pump 1001. This improves the efficiency of the heat pump as the returning heated cooled first fluid further provides additional source of heat when the heat pump provides the heated second fluid. The heat pump may simultaneously add heat to the heated second fluid.

The adsorption phase 3001 comprises the steps of cooling 4001 a first fluid up until adsorbing 4010 CO₂ from the air in the second heat exchanger 2006 via adsorption of CO₂ molecules by the CO2 sorbent. The desorption phase 3002 comprises the steps of draining 4011 the water that has been condensed from the air up until the storing 4017 of the evacuated CO₂ .

In this embodiment, the adsorption phase may last for between two and three hours and the desorption phase may last for between thirty minutes and one hour. In other embodiments, the duration of the adsorption and desorption phases may vary depending on a range of factors including but not limited to:
(a) the volume, mass, form or types of sorbent or desiccant employed
(b) PPM Co2 levels, temperature, wind speed incident on the fans, humidity and pressure of the ambient air, and consequently the amount of condensate that needs to be drained
(c) the power rating of the heat pump
(d) the size, mass and insulative properties of the apparatus, or
(e) operational requirements

### Interpretation

### 1. Markush Groups

In addition, where features or aspects of the invention are described in terms of Markush groups, those skilled in the art will recognise that the invention is also thereby described in terms of any individual member or subgroup of members of the Markush group.

### 2. Chronological Sequence

For this specification, where method steps are described in sequence, the sequence does not necessarily mean that the steps are to be carried out in chronological order in that sequence, unless there is no other logical manner of interpreting the sequence.

### 3. Embodiments

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Description of Embodiments are hereby expressly incorporated into this Description of Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### 4. Different Instances of Objects

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

### 5. Specific Details

In the description provided herein, numerous specific details are set forth. It is understood, however, that embodiments of the invention may be practiced without these specific details. In other instances, well-known methods, structures and techniques have not been shown in detail in order not to obscure an understanding of this description.

### 6. Dictionary

In describing the preferred embodiment of the invention illustrated in the drawings, specific terminology will be resorted to for the sake of clarity. The invention is, however, not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

As used herein the term “and/or” means “and” or “or”, or both.

As used herein “(s)” following a noun means the plural and/or singular forms of the noun.

As used herein the term “plurality” means, very specifically, “one or more” and not “two or more” or anything else.

As used herein the term “thermal coupling” means any region, fluid or material that is in a relationship with any other region, fluid or material where if the temperature of one increases the other will too and, conversely, if the temperature of one decreases the other will too. For absolute clarity, contact is not required for thermal coupling. Coupling may be achieved by conduction, convection or other means.

As used herein the term “connection” may denote a direct or indirect connection.

As used herein the word “line” denotes any passageway for communication of a fluid. The line is not required to be of a constant cross-section, design or even material, such may be the case with the first exchanger fluid line 1007 and the second exchanger fluid line 1012.

### 7. Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### 8. Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### 9. Industrial Applicability

It is apparent from the above, that the arrangements described are applicable to the gas capturing industries.

What is claimed is:

1. An apparatus for adsorbing and desorbing CO2 from air, the apparatus comprising:
a. a control unit;
b. a heat pump operable by the control unit;
c. a plurality of first heat exchanger systems comprising a plurality of first heat exchangers;
d. a plurality of second heat exchanger systems comprising a plurality of second heat exchangers;
e. a plurality of fan systems operable by the control unit, each fan system comprising a plurality of fans;
f. a vacuum pump operable by the control unit;
g. a plurality of first fluid lines connected to the heat pump and to each first heat exchanger of the plurality of first heat exchangers; the heat pump being adapted to:
i. provide a cooled first fluid to each first heat exchanger of the plurality of heat exchangers through the plurality of first fluid lines; and
ii. provide a heated second fluid to each first heat exchanger of the plurality of heat exchangers through the plurality of first fluid lines;
h. a plurality of second fluid lines connected to the heat pump and to each second heat exchanger of the plurality of second heat exchangers; the heat pump being adapted to provide a heated second fluid to each second heat exchanger of the plurality of second heat exchangers through the plurality of second fluid lines;
i. a plurality of return first fluid lines connected to the heat pump and to each first heat exchanger of the plurality of first heat exchangers to return the cooled first fluid and the heated second fluid to the heat pump;
j. a plurality of return second fluid lines connected to the heat pump and to each second heat exchanger of the plurality of second heat exchangers to return the heated second fluid to the heat pump;
k. a plurality of first vacuum lines connected to the vacuum pump and to each first heat exchanger of the plurality of first heat exchangers, the vacuum pump being adapted to evacuate air and/or water vapor from the plurality of first heat exchangers;
l. a plurality of second vacuum lines connected to the vacuum pump and to each second heat exchanger of the plurality of second heat exchangers, the vacuum pump being adapted to evacuate air and/or CO2 from the plurality of second heat exchangers;
m. each of the plurality of first heat exchangers comprising:
a first air filter portion in air connection with at least one fan of the plurality of fans such that operation of the at least one fan will blow air through the first air filter portion;
a first exchanger fluid line that is in fluid connection with at least one first fluid line of the plurality of first fluid lines and at least one return first fluid line of the plurality of return first fluid lines at another end; and
a desiccant located within the first air filter portion such that air that passes through the first air filter portion contacts the desiccant;
wherein the first exchanger fluid line runs through the first air filter portion and is thermally coupled with the desiccant,
such that during an adsorption phase the desiccant is cooled by the cooled first fluid increasing its adsorption capability and the at least one fan of the plurality of fans is operated by the control unit to blow air through the first air filter portion causing the air to be dehumidified, and during a desorption phase the first air filter portion is heated by the heated second fluid causing desorbtion of water accumulated therein and evacuation of the water vapor through at least one vacuum line of the plurality of first vacuum lines;
n. each of the plurality of second heat exchangers comprising:
a second air filter portion in air connection with the air that exited through a corresponding first heat exchanger of the plurality of first heat exchangers;
a second exchanger fluid line that is in fluid connection with at least one second fluid line of the plurality of second fluid lines at one end and at least one of the return second fluid lines of the plurality of return second fluid lines at another end; and
CO2 sorbent located within the second air filter portion such that air that passes through the second air filter portion contacts the CO2 sorbent;
wherein the second exchanger fluid line runs through the second air filter portion and is thermally coupled with the CO2 sorbent;
such that during the adsorption phase the sorbent adsorbs CO2 molecules from the air that passes through the second heat exchanger and is further cooled by the air which increases its adsorption capability, and during the desorption phase, the CO2 sorbent is heated by the heated second fluid causing the desorption of CO2 from the CO2 sorbent and evacuation of the desorbed CO₂ through at least one vacuum line of the plurality of second vacuum lines.

2. The apparatus for adsorbing and desorbing CO2 from air as claimed in claim 1, wherein the first air filter portion is coated with the desiccant and the second air filter portion is coated with the sorbent.

3. The apparatus for adsorbing and desorbing CO2 from air as claimed in claim 1, wherein during the adsorption phase the heat pump is adapted to provide the cooled first fluid to the plurality of second heat exchangers through the plurality of second fluid lines such that the CO2 sorbent is cooled by the cooled first fluid increasing its adsorption capability.

4. The apparatus for adsorbing and desorbing CO2 from the air as claimed in claim 1, wherein each of the plurality of first heat exchangers comprises a first air tight enclosure adapted to be controlled by the control unit to selectively enclose the first air filter portion, the first air tight enclosure being in air communication with at least one first vacuum line of the plurality of first vacuum lines.

5. The apparatus for adsorbing and desorbing CO2 from the air as claimed in claim 1, wherein each of the plurality of second heat exchangers comprises a second air tight enclosure adapted to be controlled by the control unit to selectively enclose the second air filter portion, the second air tight enclosure being in air communication with at least one second vacuum line of the plurality of second vacuum lines.

6. The apparatus for adsorbing and desorbing CO2 from the air as claimed in claim 1, further comprising a first holding tank and a second holding tank, wherein the evacuated water vapor is stored in the first holding tank and the evacuated CO2 is stored in the second holding tank.

7. The apparatus for adsorbing and desorbing CO2 from the air as claimed in claim 1, further comprising a hot fluid tank, wherein the control unit can cause the heat pump to be in fluid communication with the hot fluid tank to store hot fluid.

8. The apparatus for adsorbing and desorbing CO2 from the air as claimed in claim 1, further comprising a cold fluid tank, wherein the control unit can cause the heat pump to be in fluid communication with the cold fluid tank to store cold fluid.

9. The apparatus for adsorbing and desorbing CO2 from the air as claimed in claim 1, further comprising a drain line in fluid communication with the first air filter, such that during the adsorption phase when condensate forms, the condensate can drain out of the first air filter through the drain line.

10. The apparatus for adsorbing and desorbing CO2 from the air as claimed in claim 1, wherein the duration of the adsorption phase is between about two and three hours.

11. The apparatus for adsorbing and desorbing CO2 from the air as claimed in claim 1, wherein the duration of the desorption phase is between about thirty minutes and one hour.

12. A method of adsorbing and desorbing CO2 from air, the method comprising the steps of:
cooling a first fluid by a heat pump and heating a second fluid by the heat pump;
passing air through a first heat exchanger, the first heat exchanger comprising a first fluid path;
passing the first fluid through the first fluid path such that as the air passes through the first heat exchanger heat is transferred to the first fluid in the first fluid path;
providing a desiccant thermally coupled with the first fluid path such that: (i) the desiccant is cooled, increasing the desiccant's water adsorption capacity and the air in the first heat exchanger is dehumidified via the adsorption of water molecules by the desiccant which, in turn, causes the first fluid to be heated as the desiccant exothermically adsorbs water molecules from the air; (ii) water molecules from the air are condensed to further dehumidify the air;
passing the air that has exited the first heat exchanger through a second heat exchanger, the second heat exchanger comprising a second fluid path;
providing a CO2 sorbent thermally coupled with the second fluid path such that CO2 is adsorbed from the air as it passes through the second heat exchanger;
removing the H2O that has been condensed from the air;
evacuating the air from the first heat exchanger and the second heat exchanger;
passing the second fluid through the second fluid path to heat the CO2 sorbent such that the CO2 molecules are desorbed from the heated CO2 sorbent;
removing water vapor from the first heat exchanger;
evacuating CO2 from the second heat exchanger; and
storing the evacuated CO2 .

13. The method of adsorbing and desorbing CO2 from air as claimed in claim 12, wherein the duration of passing the air through the first heat exchanger is between about two and three hours.

14. The method of adsorbing and desorbing CO2 from air as claimed in claim 12, wherein the duration of draining the water that has been condensed from the air up until the commencement of storing the evacuated CO2 is between about thirty minutes and one hour.

15. The method of adsorbing and desorbing CO2 from air as claimed in claim 12, further comprising the step of, simultaneous or after the step of passing the first fluid through the first fluid path, passing the first fluid through the second fluid path.

16. The method of adsorbing and desorbing CO2 from air as claimed in claim 12, further comprising the step of, simultaneous or after the step of passing the heated second fluid through the second fluid path to heat the CO2 sorbent, passing the heated second fluid through the first fluid path to remove water molecules from the desiccant.

17. The method of adsorbing and desorbing CO2 from air as claimed in claim 12, further comprising the step of passing the first fluid that has been heated by the desiccant to a heat pump.
